(19) United States
(12) Patent Application Publication
(10) Pub. No.: US 2018/0366850 A1
(43) Pub. Date: Dec. 20, 2018

(54) TEST ELECTRICAL CONNECTOR AND OPERATING METHOD THEREOF

(71) Applicant: Lotes Co., Ltd, Keelung (TW)

(72) Inventors: Zuo Feng Jin, Keelung (TW); Jin Ke Hu, Keelung (TW)

(21) Appl. No.: 16/008,494

(22) Filed: Jun. 14, 2018

(30) Foreign Application Priority Data
Jun. 16, 2017 (CN) 201710454857.4

(51) Int. Cl. H01R 12/70; H01R 12/72

(52) U.S. Cl. CPC H01R 12/7011; H01R 12/721; H01R 12/7076

(57) ABSTRACT

A test electrical connector includes an insulating body, concavely provided with an insertion slot and multiple accommodating slots. The accommodating slots and an accommodating space are communicated with the insertion slot. Each accommodating slot has a channel penetrating downward through the insulating body. The channel has first and second surfaces. The first surface is obliquely provided facing the second surface. Multiple terminals are respectively accommodated in the accommodating slots. Each terminal has a connecting portion, and a contact portion and a pin respectively extend from the connecting portion. The contact portion is exposed to the insertion slot. The pin is accommodated in the channel, and has third and fourth surfaces. The third surface is obliquely provided facing the fourth surface. A gap is provided between the first surface and the third surface. An elastic body is accommodated in the accommodating space, and abuts the connecting portion.

### CROSS-REFERENCE TO RELATED PATENT APPLICATION

This non-provisional application claims priority to and the benefit of, pursuant to 35 U.S.C. § 119(a), patent application Serial No. CN201710454857.4 filed in China on Jun. 16, 2017. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to a test electrical connector, and more particularly to a test electrical connector and an operating method thereof.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

At present, after the manufacturing of memory card elements of an integrated circuit is finished, the burn-in test needs to be performed in order to screen out the memory card elements having defects in the manufacturing process. In the burn-in test, the memory card elements are generally connected onto a test circuit board by virtue of a test electrical connector, a power supply is switched on, and the temperature of a peripheral environment is increased, such that the memory card elements having defects can lose efficacy as soon as possible so as to be screened out, thereby preventing the memory card element having potential hazard from being put into use.

The existing test electrical connector mainly includes an insulating body, where the insulating body is fixed on a circuit board, and a plurality of terminals accommodated in the insulating body and an elastic body abutting the plurality of terminals. The terminals contact the contact areas on the circuit board. The insulating body is concavely provided with an insertion slot in which a memory card is inserted for testing. A clamping force is provided for the memory card by adopting the elastic body to abut the terminals, thereby ensuring the stable connection between the memory card and the test electrical connector. However, in the plugging-unplugging process of the memory card, the terminals move left and right on the contact areas due to the abutting of the elastic body to lead to the wear of the contact areas, such that the test electrical connector cannot work normally. If the circuit board is replaced, the cost is relatively high.

Therefore, a heretofore unaddressed need to design an improved electrical connector exists in the art to address the aforementioned deficiencies and inadequacies.

### SUMMARY

In view of the deficiencies in the background, the present invention is directed to a test electrical connector and an operating method thereof; and by positioning contact positions of terminals and contact areas on the circuit board, the wear of the terminals and the contact area can be reduced, thereby ensuring that the electrical connection between the test electrical connector and the circuit board is normal and stable.

To achieve the foregoing objective, the present invention uses the following technical solutions:

A test electrical connector includes: an insulating body, concavely provided with an insertion slot and a plurality of accommodating slots located at two sides of the insertion slot, wherein each of the accommodating slots is communicated with the insertion slot, and has a channel penetrating downward through the insulating body, the channel has a first surface and a second surface opposite to each other, the first surface is obliquely provided facing the second surface from top to bottom, and an accommodating space is provided in the insulating body and is communicated with the accommodating slots; a plurality of terminals, respectively accommodated in the accommodating slots, wherein each of the terminals has a connecting portion, a contact portion and a pin respectively extend from the connecting portion, the contact portion is exposed to the insertion slot, the pin is accommodated in the channel, the pin has a third surface and a fourth surface opposite to each other, the third surface is obliquely provided facing the fourth surface from top to bottom, and a gap is provided between the first surface and the third surface; and an elastic body, accommodated in the accommodating space, wherein the elastic body abuts the connecting portion.

In certain embodiments, the second surface is obliquely provided facing the first surface from top to bottom, and the fourth surface is obliquely provided facing the third surface from top to bottom.

In certain embodiments, the first surface and the second surface have a same inclination angle, and the third surface and the fourth surface have a same inclination angle.

In certain embodiments, a center line of the contact portion and a center line of the pin are perpendicular to each other.

In certain embodiments, the first surface and the second surface are symmetric about a center line of the channel, and the third surface and the fourth surface are symmetric about a center line of the pin.

In certain embodiments, a width of the gap gradually decreases from top to bottom.

In certain embodiments, the third surface and the fourth surface respectively laterally abut a bottom edge of the first surface and a bottom edge of the second surface.

In certain embodiments, the first surface is closer to the insertion slot than the second surface, and the third surface is closer to the insertion slot than the fourth surface.

In order to achieve the above objective, the present invention provides another solution as follows: a test electrical connector is configured to be electrically connected to a circuit board and to test an insertion card, where the circuit board has a plurality of contact areas. The test electrical connector includes: an insulating body, configured to be located on the circuit board, and concavely provided with a insertion slot and a plurality of accommodating slots located at two sides of the insertion slot, wherein the insertion slot is configured to be inserted by the insertion card, each of the accommodating slots is communicated with the insertion slot, and has a channel penetrating downward through the insulating body, the channel has a first surface and a second surface opposite to each other, the first surface is obliquely provided facing the second surface, and an accommodating space is provided in the insulating body and is communicated with the accommodating slots; a plurality of terminals, respectively accommodated in the accommodating slots, wherein each of the terminals has a connecting portion, a contact portion and a pin respectively extend from the connecting portion, the contact portion is exposed to the insertion slot, the pin is accommodated in the channel, the pin has a third surface and a fourth surface opposite to each other, and the third surface is obliquely provided facing the fourth surface; and an elastic body, accommodated in the accommodating space, wherein the elastic body abuts the connecting portion; wherein when the insertion card does not enter the insertion slot, the pin is configured to be in contact with the contact area to form a contact position, and when the insertion card enters the insertion slot, the pin and the contact area abut the contact position.

In certain embodiments, the pin has an abutting portion, the abutting portion is in contact with the contact area to form the contact position, and the abutting portion is provided on a center line of the pin.

In certain embodiments, the pin has an abutting portion, the abutting portion is in contact with the contact area to form the contact position, and the abutting portion is provided at one side of a center line of the pin.

In certain embodiments, the third surface laterally abuts the first surface.

In certain embodiments, a center line of the contact portion and a center line of the pin are perpendicular to each other.

In certain embodiments, the first surface and the second surface have a same inclination angle, and the third surface and the fourth surface have a same inclination angle.

In certain embodiments, the first surface is closer to the insertion slot than the second surface, and the third surface is closer to the insertion slot than the fourth surface.

In order to achieve the above objective, the present invention further provides another solution: an operating method of a test electrical connector is provided. The test electrical connector is configured to be electrically connected to a circuit board and to test an insertion card, and the circuit board has a plurality of contact areas. The operating method includes: (a) firstly forming the test electrical connector, wherein the test electrical connector includes: an insulating body, concavely provided with an insertion slot and a plurality of accommodating slots located at two sides of the insertion slot, wherein each of the accommodating slots is communicated with the insertion slot, and has a channel penetrating downward through the insulating body, the channel has a first surface and a second surface opposite to each other, the first surface is obliquely provided facing the second surface, and an accommodating space is provided in the insulating body and is communicated with the accommodating slots; a plurality of terminals, respectively accommodated in the accommodating slots, wherein each of the terminals has a connecting portion, a contact portion and a pin respectively extend from the connecting portion, the contact portion is exposed to the insertion slot, the pin is accommodated in the channel, the pin has a third surface and a fourth surface opposite to each other, and the third surface is obliquely provided facing the fourth surface; and an elastic body, accommodated in the accommodating space; and (b) after assembling the test electrical connector, then disposing the insulating body to be located on the circuit board, wherein when the pin is configured to be finally in contact with the contact area, the elastic body abuts the connecting portion and applies a first acting force to the connecting portion in a direction toward the insertion slot, and when the insertion card is inserted into the insertion slot, the insertion card abuts the contact portion and applies a second acting force to the contact portion in a direction toward the elastic body, such that the connecting portion abuts the elastic body by the contact portion and applies a third acting force to the elastic body in a direction away from the insertion slot.

In certain embodiments, each of the terminals is switchable among an initial state, a locking state and a working state; in the initial state, the insulating body is not configured to be located on the circuit board, and the third surface and the fourth surface respectively laterally abut a bottom edge of the first surface and a bottom edge of the second surface; in the locking state, the insulating body is configured to be located on the circuit board, the terminal moves upward along the channel, the third surface laterally abuts the first surface, the elastic body abuts the connecting portion and applies the first acting force to the connecting portion in the direction toward the insertion slot, and the pin is configured to be in contact with the contact area to form a contact position; and in the working state, the insertion card enters the insertion slot, the first surface and the second surface do not abut the third surface and the fourth surface, the insertion card abuts the contact portion and applies the second acting force to the contact portion in the direction toward the elastic body, and the pin and the contact area abut the contact position.

In certain embodiments, when each of the terminals is in the initial state or in the working state, the first surface and the second surface respectively have gaps with the third surface and the fourth surface, and when each of the terminals is in the locking state, a gap is provided between the second surface and the fourth surface.

In certain embodiments, when each of the terminals is in the working state, the connecting portion abuts the elastic body and applies the third acting force to the elastic body, such that the elastic body is forced to be elastically deformed.

In certain embodiments, the first surface is closer to the insertion slot than the second surface, and the third surface is closer to the insertion slot than the fourth surface.

Compared with the related art, certain embodiments of the present invention has the following beneficial effects:

The channel of the test electrical connector has a first surface and a second surface opposite to each other, and the first surface is obliquely provided facing the second surface. The pin has a third surface and a fourth surface opposite to each other, and the third surface is obliquely provided facing the fourth surface. When each of the terminals is in the initial state, the locking state or the working state, the contact position formed by the pin contacting the contact areas always remains unchanged. In other words, the pin does not move left and right on the contact areas, thereby reducing the wear of the terminals and the contact areas, prolonging the service life of the test electrical connector, and ensuring the stable connection between the test electrical connector and the circuit board.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective exploded view of a test electrical connector according to a first embodiment of the present invention.

FIG. 2 is a perspective exploded view of another state of the test electrical connector according to the first embodiment of the present invention.

FIG. 3 is a perspective local assembled view of the test electrical connector according to the first embodiment of the present invention.

FIG. 4 is a perspective assembled view of the test electrical connector according to the first embodiment of the present invention.

FIG. 5 is a local sectional view of the test electrical connector according to the first embodiment of the present invention.

FIG. 6 is a sectional view of an initial state of the test electrical connector according to the first embodiment of the present invention.

FIG. 7 is a sectional view of a locking state of the test electrical connector according to the first embodiment of the present invention.

FIG. 8 is a sectional view of a working state of the test electrical connector according to the first embodiment of the present invention.

FIG. 9 is an enlarged view of a portion a in FIG. 8.

FIG. 10 is a structural schematic view of a terminal of a test electrical connector according to a second embodiment of the present invention.

FIG. 11 is a structural schematic view of another terminal of the test electrical connector according to the second embodiment of the present invention.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

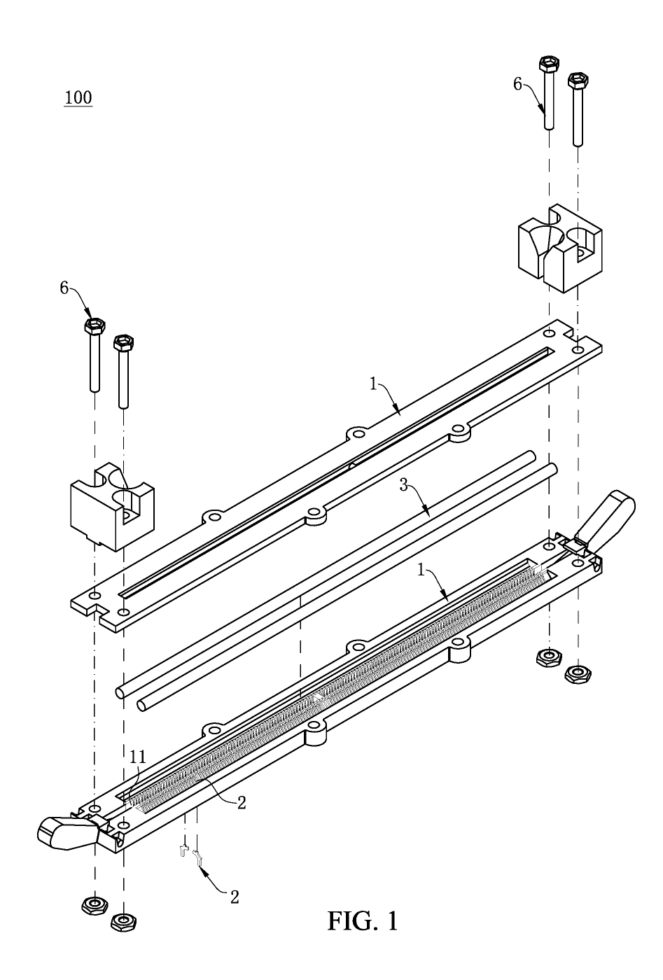

The description will be made as to the embodiments of the present invention in conjunction with the accompanying drawings in FIGS. 1-11. In accordance with the purposes of this invention, as embodied and broadly described herein, this invention, in one aspect, relates to a test electrical connector and an operating method thereof.

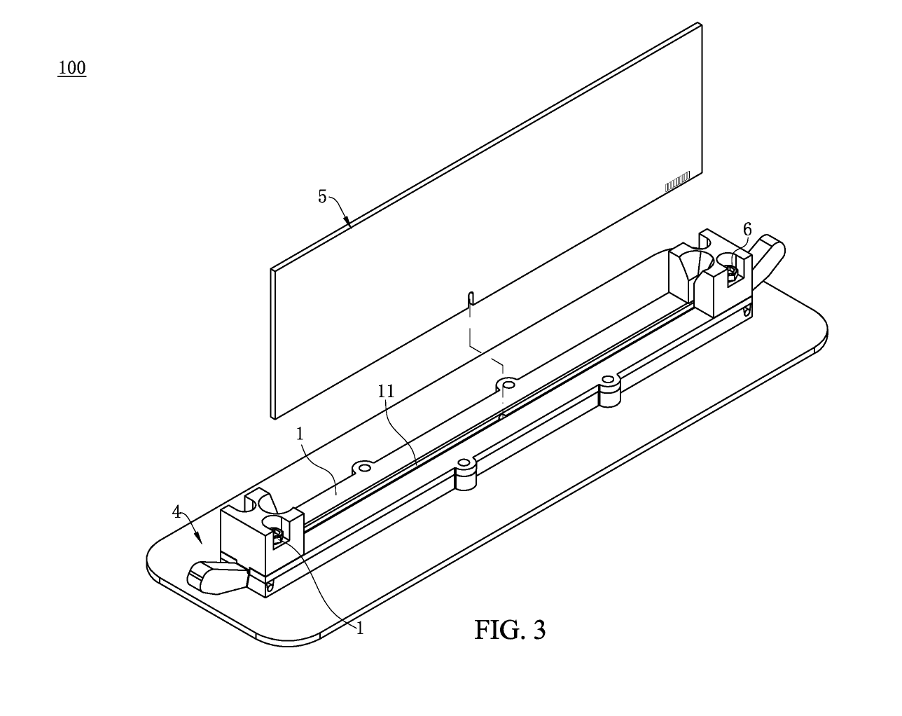

As shown in FIG. 1 and FIG. 3, a test electrical connector 100 according to a first embodiment of the present invention is electrically connected to a circuit board 4 and configured to test an insertion card 5. The test electrical connector 100 includes an insulating body 1, a plurality of terminals 2 and an elastic body 3 accommodated in the insulating body 1.

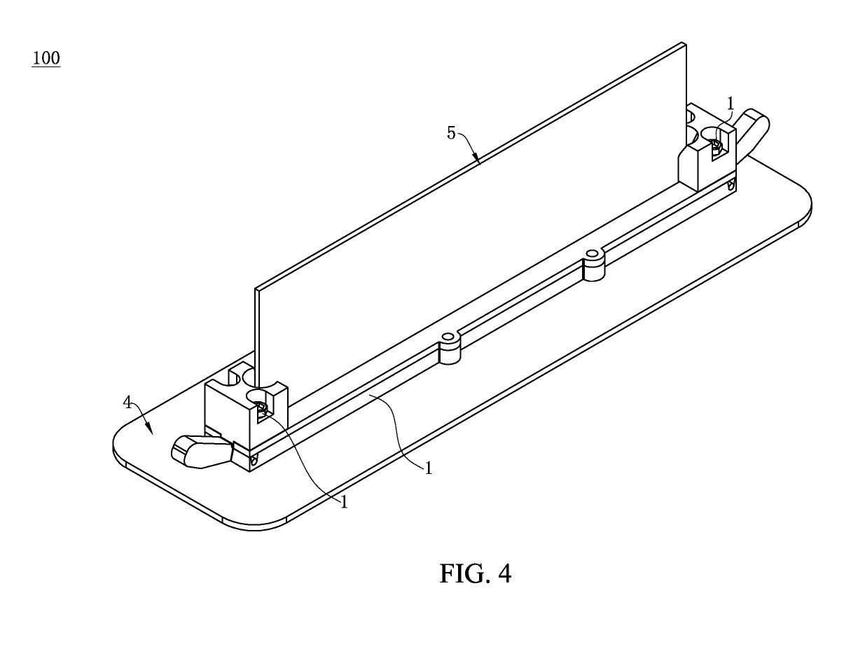

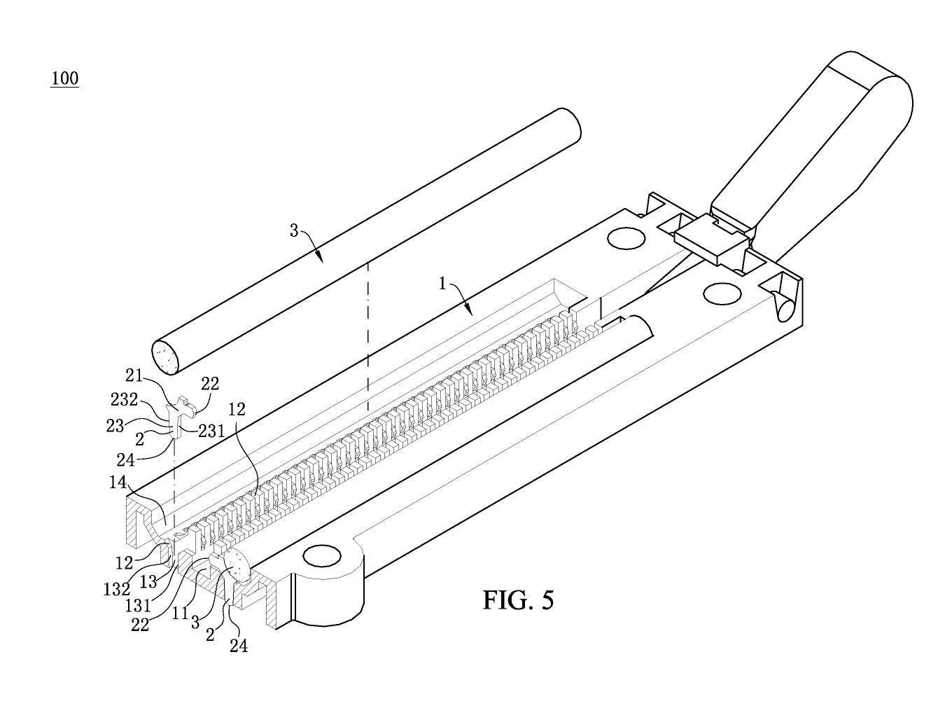

As shown in FIG. 4 and FIG. 5, the insulating body 1 is located on the circuit board 4. The circuit board 4 has a plurality of contact areas 41. The insulating body 1 is concavely provided with an insertion slot 11, and the insertion slot 11 is configured to be inserted by the insertion card 5. The insulating body 1 is concavely provided with a plurality of accommodating slots 12 at two sides of the insertion slot 11, and each of the accommodating slots 12 is communicated with the insertion slot 11. Each of the accommodating slots 12 has a channel 13 penetrating downward through a bottom portion of the insulating body 1. The insulating body 1 has an accommodating space 14, and one side of the accommodating space 14 is communicated with the accommodating slots 12.

The channel 13 has a first surface 131 and a second surface 132 opposite to each other. The first surface 131 and the second surface 132 are respectively obliquely provided facing each other at a same inclination angle from top to bottom, and are laterally symmetrical about a center line of the channel 13. The first surface 131 is closer to the insertion slot 11 than the second surface 132.

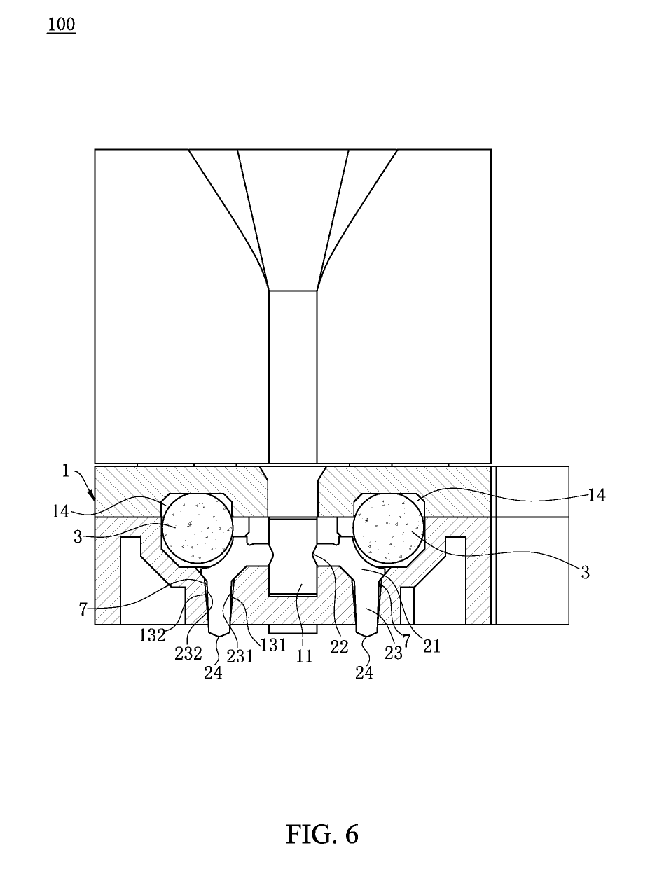

As shown in FIG. 5 and FIG. 6, the terminals 2 are respectively accommodated in the accommodating slots 12. Each of the terminals 2 has a connecting portion 21, and the connecting portion 21 has an arc surface. A contact portion 22 and a pin 23 respectively extend from the connecting portion 21. A center line of the contact portion 22 and a center line of the pin 23 are perpendicular to each other. The contact portion 22 is exposed to the insertion slot 11. The pin 23 is accommodated in the channel 13. The pin 23 has an abutting portion 24 provided on the center line of the pin 23, and the abutting portion 24 is configured to be in contact with the contact area 41 to form a contact position 25. The pin 23 has a third surface 231 and a fourth surface 232 opposite to each other. The third surface 231 and the fourth surface 232 are i respectively obliquely provided facing each other at a same inclination angle from top to bottom, and the third surface 231 and the fourth surface 232 are laterally symmetrical about the center line of the pin 23. The third surface 231 is closer to the insertion slot 11 than the fourth surface 232.

As shown in FIG. 6, the elastic body 3 is accommodated in the accommodating space 14. The elastic body 3 is a cylinder, and the elastic body 3 abuts the arc surface of the connecting portion 21.

An operating method of the test electrical connector 100 is provided. In a first step of the operating method, the test electrical connector 100 is formed. Then, after assembling the test electrical connector 100, the insulating body 1 is disposed to be located on the circuit board 4. As shown in FIG. 6, when the insulating body 1 is not fixed on the circuit board 4, each terminal 2 is in an initial state. The third surface 231 and the fourth surface 232 respectively abut a bottom edge of the first surface 131 and a bottom edge of the second surface 132, such that when the insulating body 1 is fixed on the circuit board 4, the terminal 2 can be positioned to enable the abutting portion 24 not to move left and right. In the initial state, a gap 7 is provided between the first surface 131 and the third surface 231, and a gap 7 is provided between the second surface 132 and the fourth surface 232.

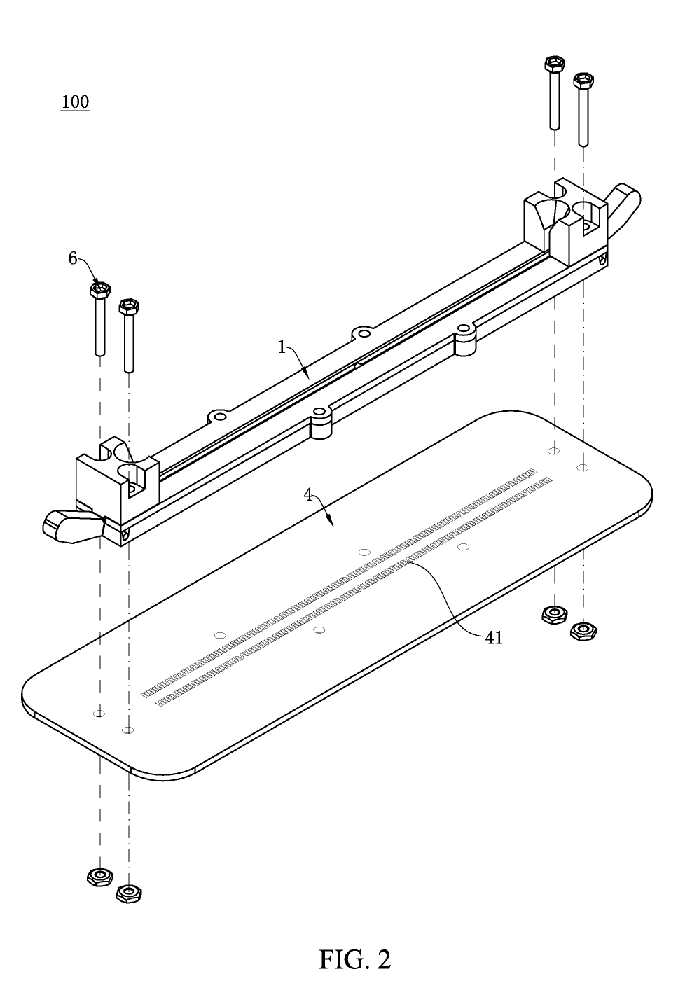

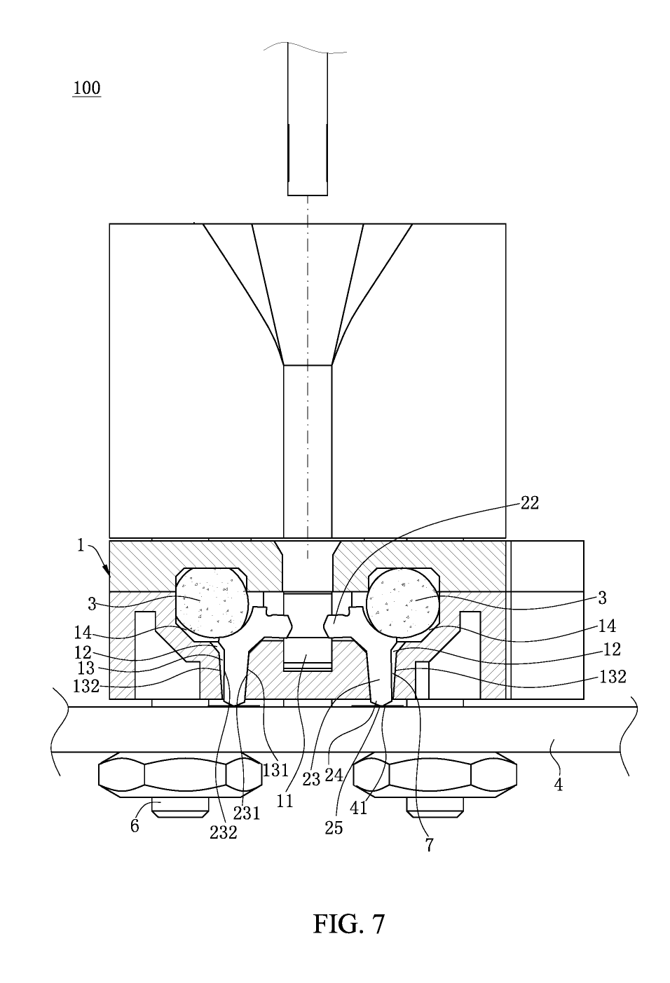

As shown in FIG. 2 and FIG. 7, the insulating body 1 and the circuit board 4 have a plurality of through holes correspondingly provided thereon. Multiple bolts 6 respectively penetrate through the through holes to lock the insulating body 1 and the circuit board 4 in a vertical direction. The abutting portion 24 contacts the contact area 41 to form a contact position 25. The insertion card 5 is not inserted into the insertion slot 11, and each terminal 2 is in a locking state. The terminal 2 moves upward along the channel 13, and the contact position 25 formed by the abutting portion 24 and the contact area 41 remains unchanged. The elastic body 3 abuts the connecting portion 21 and applies a first acting force to the connecting portion 21, and the first acting force can be broken down into a first acting sub-force in the direction toward the contact portion 22 and a second acting sub-force in the direction toward the pin 23, such that the terminal 2 is inclined toward the insertion slot 11, and the third surface 231 laterally abuts the first surface 131.

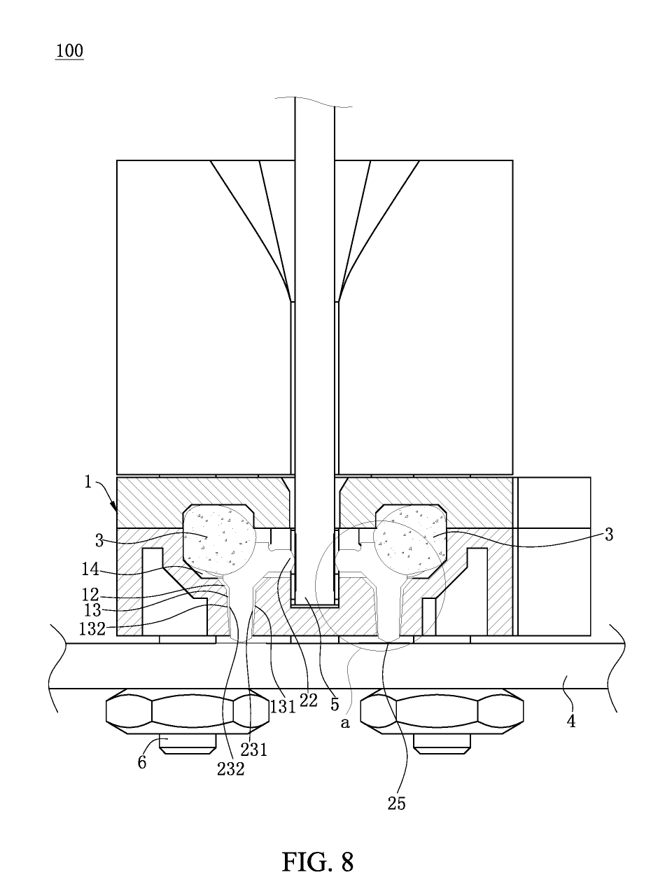

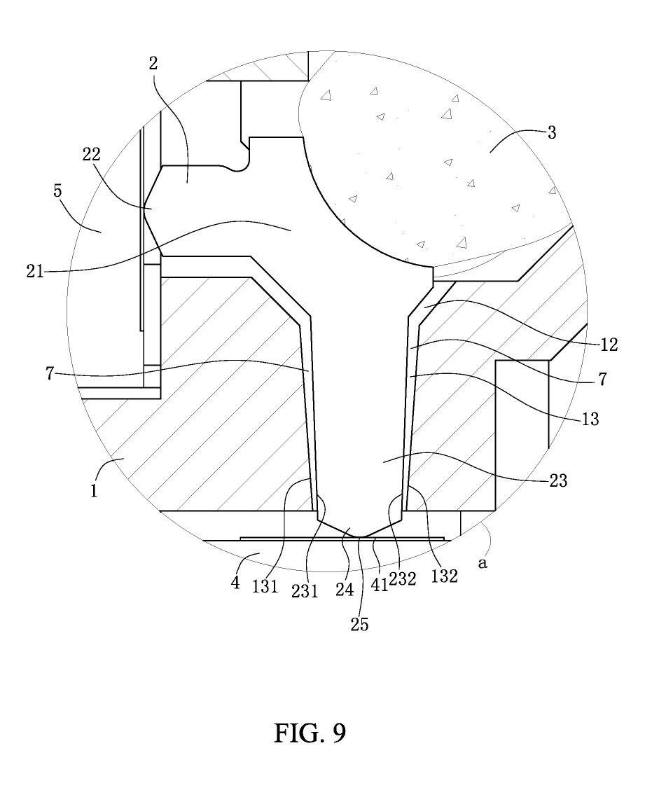

As shown in FIG. 8 and FIG. 9, when the insertion card 5 enters the insertion slot 11, the insertion card 5 abuts the contact portion 22 and applies a second acting force to the contact portion 22 to enable the contact portion 22 to move toward the elastic body 3, and each terminal 2 is in a working state. The connecting portion 21 abuts the elastic body 3 and applies a third acting force to the elastic body 3 in a direction away from the insertion slot 11 so as to enable the elastic body 3 to be elastically deformed. The third acting force can be broken down into a third acting sub-force applied toward the elastic body 3 by the contact portion 22 and a fourth acting sub-force downward applied toward the pin 23 by the elastic body 3. The first acting sub-force and the third acting sub-force are a pair of balance forces, such that the pin 23 is kept upright. The second acting sub-force and the fourth acting sub-force are a pair of balance forces, such that the abutting portion 24 does not move in a left-right direction, i.e., the contact position 25 formed by the abutting portion 24 and the contact area 41 remains unchanged. The third surface 231 and the fourth surface 232 do not abut the first surface 131 and the second surface 132. A gap 7 is provided between the first surface 131 and the third surface 231, a gap 7 is provided between the second surface 132 and the fourth surface 232, and the gaps 7 gradually decrease from top to bottom.

When the terminals 2 of the test electrical connector 100 are in the locking state or the working state, the contact position 25 formed by the abutting portion 24 contacting the contact area 41 remains unchanged, thereby preventing the wear of the abutting portion 24 and the contact area 41 caused by the left-right movement of the abutting portion 24 on the contact area 41 due to the plugging and unplugging of the insertion card 5.

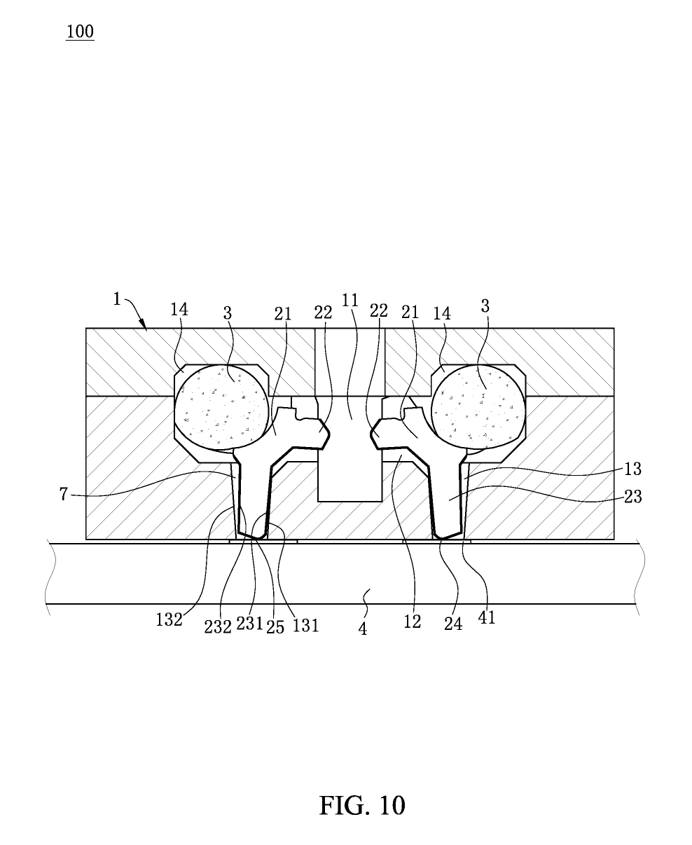

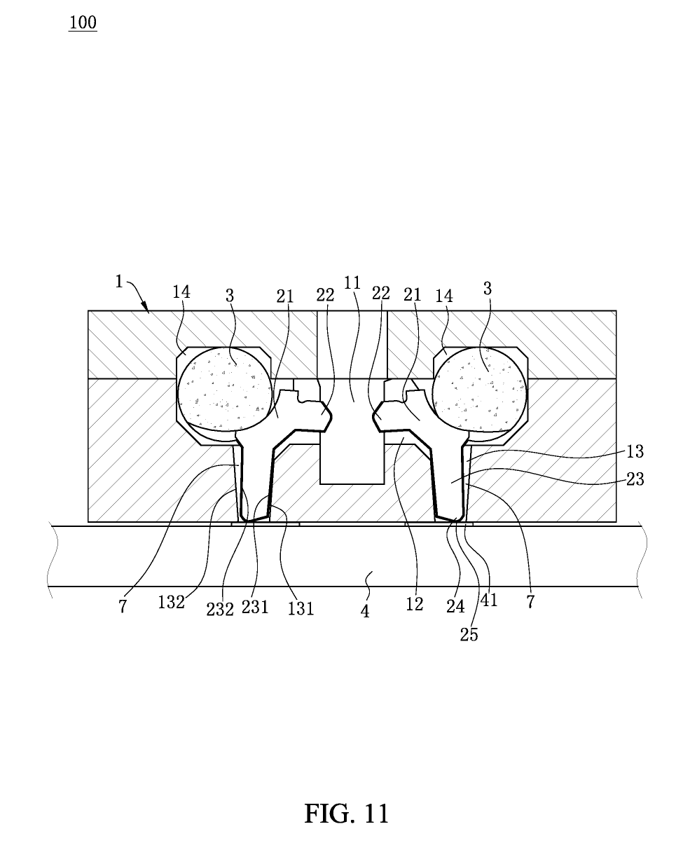

FIG. 10 and FIG. 11 show a second embodiment of the present invention, which differs from the first embodiment in that: the abutting portion 24 is provided at one side of the center line of the pin 23, i.e., the abutting portion 24 is closer to the insertion slot 11 relative to the center line of the pin 23 (as shown in FIG. 10), or the abutting portion 24 is farther from the insertion slot 11 relative to the center line of the pin 23 (as shown in FIG. 11). When the contact position 25 on the contact area 41 in the first embodiment is worn, a terminal 2 in the second embodiment can be used as the replacement, such that the abutting portion 24 in the second embodiment abuts the same contact area 41 to form another contact position 25, without the need for replacing the circuit board 4. Further detailed description is not elaborated herein.

To sum up, the electrical connector 100 according to certain embodiments of the present invention has the following beneficial effects:

(1) The channel 13 of the test electrical connector 100 has a first surface 131 and a second surface 132 opposite to each other, and the first surface 131 is obliquely provided facing the second surface 132. The pin 23 has a third surface 231 and a fourth surface 232 opposite to each other, and the third surface 231 is obliquely provided facing the fourth surface 232. When each of the terminals 2 is in the initial state, the locking state or the working state, the contact position 25 formed by the pin 23 contacting the contact area 41 always remains unchanged, i.e., the pin 23 does not move left and right on the contact area 41, thereby reducing the wear of the terminal 2 and the contact area 41, prolonging the service life of the test electrical connector 100, and ensuring the stable connection between the test electrical connector 100 and the circuit board 4;

(2) When the terminal 2 is in the initial state, the third surface 231 and the fourth surface 232 respectively abut the bottom edge of the first surface 131 and the bottom edge of the second surface 132, such that the terminal 2 can be positioned to enable the abutting portion 24 not to move left and right when the insulating body 1 is fixed on the circuit board 4, thereby reducing the wear of the terminal 2 and the contact area 41, prolonging the service life of the test electrical connector 100, and ensuring the stable connection between the test electrical connector 100 and the circuit board 4;

(3) The insulating body 1 is fixed on the circuit board 4 through the bolts 6, and the abutting portion 24 contacts the contact area 41 to form a contact position 25. The insertion card 5 is not inserted into the insertion slot 11, and the terminal 2 is in the locking state. The terminal 2 moves upward along the channel 13, and the contact position 25 formed by the abutting portion 24 and the contact area 41 remains unchanged. The elastic body 3 abuts the connecting portion 21 and applies a first acting force to the connecting portion 21, the terminal 2 is inclined towards the insertion slot 11, and the third surface 231 laterally abuts the first surface 131. The terminal 2 is positioned to enable the abutting portion 24 not to move left and right, thereby reducing the wear of the terminal 2 and the contact area 41, prolonging the service life of the test electrical connector 100, ensuring the stable connection between the test electrical connector 100 and the circuit board 4, where the first acting force provide a sufficient clamping force to clamp the insertion card 5 when the insertion card 5 is inserted;

(4) When the insertion card 5 enters the insertion slot 11, the insertion card 5 abuts the contact portion 22 to enable the contact portion 22 to move toward the elastic body 3, and the terminal 2 is in the working state. The connecting portion 21 abuts the elastic body 3 and applies a third acting force to the elastic body 3 in a direction away from the insertion slot 11 so as to enable the elastic body 3 to be elastically deformed. The first acting force and the third acting force are a pair of balance forces, such that the abutting portion 24 does not move left and right, i.e., the contact position 25 formed by the abutting portion 24 and the contact area 41 remains unchanged, thereby reducing the wear of the terminal 2 and the contact area 41, prolonging the service life of the test electrical connector 100, and ensuring the stable connection between the test electrical connector 100 and the circuit board 4; and

(5) The abutting portion 24 is provided at one side of the center line of the pin 23, i.e., the abutting portion 24 is closer to the insertion slot 11 relative to the center line of the pin 23, or the abutting portion 24 is farther from the insertion slot 11 relative to the center line of the pin 23. When the contact position 25 on the contact area 41 in the first embodiment is worn, the terminal 2 in the second embodiment can be used as the replacement, such that the abutting portion 24 in the second embodiment abuts the same contact area 41 to form another contact position 25, without the need for replacing the circuit board 4, thereby reducing the cost.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A test electrical connector, comprising:
an insulating body, concavely provided with an insertion slot and a plurality of accommodating slots located at two sides of the insertion slot, wherein each of the accommodating slots is communicated with the insertion slot, and has a channel penetrating downward through the insulating body, the channel has a first surface and a second surface opposite to each other, the first surface is obliquely provided facing the second surface from top to bottom, and an accommodating space is provided in the insulating body and is communicated with the accommodating slots;
a plurality of terminals, respectively accommodated in the accommodating slots, wherein each of the terminals has a connecting portion, a contact portion and a pin respectively extend from the connecting portion, the contact portion is exposed to the insertion slot, the pin is accommodated in the channel, the pin has a third surface and a fourth surface opposite to each other, the third surface is obliquely provided facing the fourth surface from top to bottom, and a gap is provided between the first surface and the third surface; and
an elastic body, accommodated in the accommodating space, wherein the elastic body abuts the connecting portion.

2. The test electrical connector according to claim 1, wherein the second surface is obliquely provided facing the first surface from top to bottom, and the fourth surface is obliquely provided facing the third surface from top to bottom.

3. The test electrical connector according to claim 2, wherein the first surface and the second surface have a same inclination angle, and the third surface and the fourth surface have a same inclination angle.

4. The test electrical connector according to claim 1, wherein a center line of the contact portion and a center line of the pin are perpendicular to each other.

5. The test electrical connector according to claim 1, wherein the first surface and the second surface are symmetric about a center line of the channel, and the third surface and the fourth surface are symmetric about a center line of the pin.

6. The test electrical connector according to claim 1, wherein a width of the gap gradually decreases from top to bottom.

7. The test electrical connector according to claim 1, wherein the third surface and the fourth surface respectively laterally abut a bottom edge of the first surface and a bottom edge of the second surface.

8. The test electrical connector according to claim 1, wherein the first surface is closer to the insertion slot than the second surface, and the third surface is closer to the insertion slot than the fourth surface.

9. A test electrical connector, configured to be electrically connected to a circuit board and to test an insertion card, the circuit board having a plurality of contact areas, the test electrical connector comprising:
an insulating body, configured to be located on the circuit board, and concavely provided with an insertion slot and a plurality of accommodating slots located at two sides of the insertion slot, wherein the insertion slot is configured to be inserted by the insertion card, each of the accommodating slots is communicated with the insertion slot, and has a channel penetrating downward through the insulating body, the channel has a first surface and a second surface opposite to each other, the first surface is obliquely provided facing the second surface, and an accommodating space is provided in the insulating body and is communicated with the accommodating slots;
a plurality of terminals, respectively accommodated in the accommodating slots, wherein each of the terminals has a connecting portion, a contact portion and a pin respectively extend from the connecting portion, the contact portion is exposed to the insertion slot, the pin is accommodated in the channel, the pin has a third surface and a fourth surface opposite to each other, and the third surface is obliquely provided facing the fourth surface; and
an elastic body, accommodated in the accommodating space, wherein the elastic body abuts the connecting portion;
wherein when the insertion card does not enter the insertion slot, the pin is configured to be in contact with the contact area to form a contact position, and when the insertion card enters the insertion slot, the pin and the contact area abut the contact position.

10. The test electrical connector according to claim 9, wherein the pin has an abutting portion, the abutting portion is in contact with the contact area to form the contact position, and the abutting portion is provided on a center line of the pin.

11. The test electrical connector according to claim 9, wherein the pin has an abutting portion, the abutting portion is in contact with the contact area to form the contact position, and the abutting portion is provided at one side of a center line of the pin.

12. The test electrical connector according to claim 9, wherein the third surface laterally abuts the first surface.

13. The test electrical connector according to claim 9, wherein a center line of the contact portion and a center line of the pin are perpendicular to each other.

14. The test electrical connector according to claim 9, wherein the first surface and the second surface have a same inclination angle, and the third surface and the fourth surface have a same inclination angle.

15. The test electrical connector according to claim 9, wherein the first surface is closer to the insertion slot than the second surface, and the third surface is closer to the insertion slot than the fourth surface.

16. An operating method of a test electrical connector, the test electrical connector being configured to be electrically connected to a circuit board and to test an insertion card, the circuit board having a plurality of contact areas, the operating method comprising:
(a) firstly, forming the test electrical connector, wherein the test electrical connector comprises:
an insulating body, concavely provided with an insertion slot and a plurality of accommodating slots located at two sides of the insertion slot, wherein each of the accommodating slots is communicated with the insertion slot, and has a channel penetrating downward through the insulating body, the channel has a first surface and a second surface opposite to each other, the first surface is obliquely provided facing the second surface, and an accommodating space is provided in the insulating body and is communicated with the accommodating slots;
a plurality of terminals, respectively accommodated in the accommodating slots, wherein each of the terminals has a connecting portion, a contact portion and a pin respectively extend from the connecting portion, the contact portion is exposed to the insertion slot, the pin is accommodated in the channel, the pin has a third surface and a fourth surface opposite to each other, and the third surface is obliquely provided facing the fourth surface; and
an elastic body, accommodated in the accommodating space; and
(b) after assembling the test electrical connector, then disposing the insulating body to be located on the circuit board,
wherein when the pin is configured to be finally in contact with the contact area, the elastic body abuts the connecting portion and applies a first acting force to the connecting portion in a direction toward the insertion slot, and when the insertion card is inserted into the insertion slot, the insertion card abuts the contact portion and applies a second acting force to the contact portion in a direction toward the elastic body, such that the connecting portion abuts the elastic body by the contact portion and applies a third acting force to the elastic body in a direction away from the insertion slot.

17. The operating method of the test electrical connector according to claim 16, wherein:
each of the terminals is switchable among an initial state, a locking state and a working state;
in the initial state, the insulating body is not configured to be located on the circuit board, and the third surface and the fourth surface respectively laterally abut a bottom edge of the first surface and a bottom edge of the second surface;
in the locking state, the insulating body is configured to be located on the circuit board, the terminal moves upward along the channel, the third surface laterally abuts the first surface, the elastic body abuts the connecting portion and applies the first acting force to the connecting portion in the direction toward the insertion slot, and the pin is configured to be in contact with the contact area to form a contact position; and
in the working state, the insertion card enters the insertion slot, the first surface and the second surface do not abut the third surface and the fourth surface, the insertion card abuts the contact portion and applies the second acting force to the contact portion in the direction toward the elastic body, and the pin and the contact area abut the contact position.

18. The operating method of the test electrical connector according to claim 17, wherein when each of the terminals is in the initial state or in the working state, a gap is provided between the first surface and the third surface and a gap is provided between the second surface and the fourth surface, and when each of the terminals is in the locking state, a gap is provided between the second surface and the fourth surface.

19. The operating method of the test electrical connector according to claim 17, wherein when each of the terminals is in the working state, the connecting portion abuts the elastic body and applies the third acting force to the elastic body, such that the elastic body is forced to be elastically deformed.

20. The operating method of the test electrical connector according to claim 16, wherein the first surface is closer to the insertion slot than the second surface, and the third surface is closer to the insertion slot than the fourth surface.
